(19) United States
(12) Patent Application Publication
(10) Pub. No.: US 2024/0043958 A1
(43) Pub. Date: Feb. 8, 2024

(54) SAFE REACTOR FOR LEACHING OF WASTE BATTERY POWDER AND CAPABLE OF CONTROLLING HYDROGEN CONCENTRATION

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP VEHICLES RECYCLING CO., LTD., Changsha, Hunan (CN)

(72) Inventors: Haijun YU, Foshan, Guangdong (CN); Changdong LI, Foshan, Guangdong (CN); Yinghao XIE, Foshan, Guangdong (CN); Xuemei ZHANG, Foshan, Guangdong (CN); Kang CHEN, Foshan, Guangdong (CN)

(73) Assignees: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP VEHICLES RECYCLING CO., LTD., Changsha, Hunan (CN)

(21) Appl. No.: 18/265,378

(22) PCT Filed: Dec. 30, 2021
(86) PCT No.: PCT/CN2021/142934

§ 371 Date: Jun. 5, 2023

(30) Foreign Application Priority Data
Jun. 2, 2021 (CN) 202110615653.0

(51) Int. Cl. C22B 3/02; C22B 7/00; H01M 10/54

(52) U.S. Cl. CPC C22B 3/02; C22B 7/007; H01M 10/54

(57) ABSTRACT

A hydrogen concentration-controllable safe reaction tank for leaching of waste battery powder, includes at bed provided with supporting frames and a driver; a rotary acid pumping barrel articulated with the supporting frames, the driver being configured to drive the rotary acid pumping barrel to rotate, and a delivery pipe mounted on the bed and passing through the rotary acid pumping barrel where a screw for pushing material is disposed in the delivery pipe; the delivery pipe includes a pouring section located in the rotary acid pumping barrel, the pouring section is provided with a pouring opening at an upper portion and acid leakage holes at a bottom, and at least one acid pumping plate is mounted on an inner wall of the rotary acid pumping barrel.

### CROSS-REFERENCE TO RELATED APPLICATION

This application is a national stage filing under 35 U.S.C. § 371 of international application number PCT/CN2021/142934, filed Dec. 30, 2021, which claims priority to Chinese patent application No. 202110615653.0 filed Jun. 2, 2021. The contents of these applications are incorporated herein by reference in their entirety.

### TECHNICAL FIELD

The present disclosure relates to the technical field of recycling in the new energy material industry, and in particular to a hydrogen concentration-controllable safe reaction tank for leaching of waste battery powder.

### BACKGROUND

With the constant increase of demand on environment protection, an enormous quantity of discarded waste batteries needs to be recycled. A lot of important rare metallic elements are contained in waste batteries, and at present, the recycling rate of lithium, nickel, cobalt, manganese and the like can reach more than 99%. Recycling power batteries is not only favorable for the recycling of resources, but also can alleviate the problem of raw material supply and reduce cost. Moreover, since high toxic materials and volatile materials, such as lithium hexafluorophosphate, are contained in waste batteries, if these waste batteries are not properly disposed, an adverse impact will be posed on the ecological environment. Furthermore, in the process of dismantling waste batteries, misoperation will lead to burning, explosion and electric shock accidents, and in addition, there also exist potential safety hazards, such as corrosion.

In the process of battery recycling, in order to obtain pure battery powder, a leaching process is required for waste powder of waste batteries. The leaching process is a process which adopts the pickling method to purify battery powder and remove aluminum, and a great deal of hydrogen will be generated in the process of reaction. Since the explosive limit of hydrogen is 4.0% to 75.6% (volume concentration), hydrogen will explode when encountering fire if the volume concentration of hydrogen in the air is between 4.0% and 75.6%, whereas hydrogen will not explode even when encountering fire if the concentration of hydrogen is less than 4.0% or greater than 75.6%.

In the process of feeding and discharge of current art, the internal space of a reaction zone in current battery powder leaching equipment is communicated with the atmosphere. The volumetric mixing of the outside air and hydrogen in a sealed field may lead to the fact that the volume concentration of the hydrogen generated by reaction can easily fall within the explosive limit range, and as a result, the hydrogen will explode when encountering fire, causing enormous property loss and even casualties.

### SUMMARY

In order to solve at least one of the technical problems existing in the prior art, the present disclosure proposes a hydrogen concentration-controllable safe reaction tank for leaching of waste battery powder in which a reaction zone and a feeding and discharge zone are always kept outside the explosive limit of hydrogen.

According to an embodiment of a first aspect of the present disclosure, the hydrogen concentration-controllable safe reaction tank for leaching of waste battery powder according to an embodiment of a first aspect of the present disclosure includes a bed, a rotary acid pumping barrel and a delivery pipe, wherein supporting frames and a driver are mounted on the bed; the rotary acid pumping barrel is articulated with the supporting frames, and the driver is configured to drive the rotary acid pumping barrel to rotate; the delivery pipe is mounted on the bed and passes through the rotary acid pumping barrel, and a screw for pushing material is disposed in the delivery pipe; and the delivery pipe includes a pouring section located in the rotary acid pumping barrel, the pouring section is provided with a pouring opening at an upper portion and acid leakage holes at a bottom, at least one acid pumping plate is mounted on an inner wall of the rotary acid pumping barrel, and the driver is configured to drive the rotary acid pumping barrel to rotate, so that the acid pumping plate can scoop up an acid liquor and pour the acid liquor into the pouring section.

According to the embodiment of the present disclosure, the hydrogen concentration-controllable safe reaction tank for leaching of waste battery powder at least has the following technical effects: since the screw is adopted for delivery and the acid pumping plate is adopted for pouring, the degree of sufficiency of waste battery powder reaction is increased; and the cooperation between the screw and the delivery pipe effectively blocks the outside atmosphere from communicating with the air in the rotary acid pumping barrel, thus preventing the change of the volume concentration of hydrogen in the rotary acid pumping barrel caused by the mutual communication of air, preventing the hydrogen from leaking out and facilitating the control of the volume concentration of the hydrogen.

According to some embodiments of the present disclosure, taking a first cross section of the rotary acid pumping barrel, the acid pumping plate is arc-shaped in the first cross section, and a concave portion of the acid pumping plate faces outside the rotary acid pumping barrel.

According to some embodiments of the present disclosure, taking a second cross section of the pouring section, an included angle between both ends of the pouring opening is defined as α in the second cross section, and α<180°.

According to some embodiments of the present disclosure, the hydrogen concentration-controllable safe reaction tank for leaching of waste battery powder leaching further includes a gas storage device, which includes a vacuum pump and a reservoir. The vacuum pump has a gas outlet end connected to the reservoir and a gas suction end communicating with the interior of the rotary acid pumping barrel.

According to some embodiments of the present disclosure, the hydrogen concentration-controllable safe reaction tank for leaching of waste battery powder further includes a controller. A hydrogen detector is mounted in the rotary acid pumping barrel, and the controller is electrically connected to the hydrogen detector, the vacuum pump and the driver, respectively.

According to some embodiments of the present disclosure, one end of the delivery pipe is an opening, while the other end is a seal. The opening is provided with a downwardly bending elbow, and the delivery pipe is provided with a feed inlet at a portion close to the seal. A feed hopper is disposed over the feed inlet, with an outlet end of the feed hopper being sealingly connected to the feed inlet.

According to some embodiments of the present disclosure, the supporting frames support left and right ends of the rotary acid pumping barrel. The driver includes driving wheels and motors, and the driving wheels are mounted under the rotary acid pumping barrel and abut against the external surface of the rotary acid pumping barrel.

According to some embodiments of the present disclosure, the rotary acid pumping barrel is provided with a sealing door.

According to some embodiments of the present disclosure, the surface of the driving wheel is provided with a rubber layer.

According to some embodiments of the present disclosure, the screw and an inner wall of the delivery pipe are coated with plastic layers.

The additional aspects and advantages of the present disclosure will be partially set forth in the following description, and will partially become apparent from the following description or be understood through practice of the present disclosure.

### BRIEF DESCRIPTION OF DRAWINGS

The additional aspects and advantages of the present disclosure will become apparent and easily comprehensible from the description of embodiments with reference to the following accompanying drawings, in which:

FIG. 1 is a schematic structural diagram of a hydrogen concentration-controllable safe reaction tank for leaching of waste battery powder according to a first embodiment of the present disclosure;

FIG. 2 is a partial cross-sectional view of the safe reaction tank shown in FIG. 1;

FIG. 3 is a cross-sectional view taken along a line A-A of a first case of a delivery pipe shown in FIG. 2;

FIG. 4 is a cross-sectional view taken along the line A-A of a second case of the delivery pipe shown in FIG. 2;

FIG. 5 is a schematic structural diagram of a hydrogen concentration-controllable safe reaction tank for leaching of waste battery powder according to a second embodiment of the present disclosure; and

FIG. 6 is a schematic structural diagram showing the connection between a driver and a rotary acid pumping barrel.

Reference numerals: bed 100, supporting frame 110, driver 120, driving wheel 121, motor 122, rotary acid pumping barrel 200, acid pumping plate 210, first cross section 220, sealing door 230, delivery pipe 300, screw 310, pouring section 320, pouring opening 321, acid leakage hole 322, second cross section 323, elbow 330, feed inlet 340, feed hopper 350, gas storage device 400, waste battery powder 500 and acid liquor 600.

### DETAILED DESCRIPTION

The embodiments of the present disclosure are described in detail below, and the examples of the embodiments are shown in the accompanying drawings, throughout which identical or similar reference numerals represent identical or similar elements or elements having identical or similar functions. The embodiments described below by reference to the accompanying drawings are exemplary and are merely intended to explain the present disclosure rather than be construed as limiting the present disclosure.

In the description of the present disclosure, “multiple” means two or more. “Greater than”, “less than” and the like should be understood as excluding this number, while “more than” and the like should be understood as including this number. It should be understood that with regard to directional description, directions or positional relationships indicated by, for example, “upper”, “lower”, “front”, “rear”, “left”, “right” and “middle” are based on directions or positional relationships shown in the accompanying drawings. The directions or positional relationships are merely intended to facilitate and simplify the description of the present disclosure rather than indicate or imply that the indicated device or elements must have specific directions and be structured and operated according to the specific directions, and therefore cannot be understood as a limitation to the present disclosure.

In the description of the present disclosure, unless explicitly defined otherwise, the words such as “mount” and “connect” should be understood in a broad sense, and those skilled in the art can reasonably determine the specific meanings of the aforementioned words in the present disclosure in conjunction with the specific contents of the technical solution.

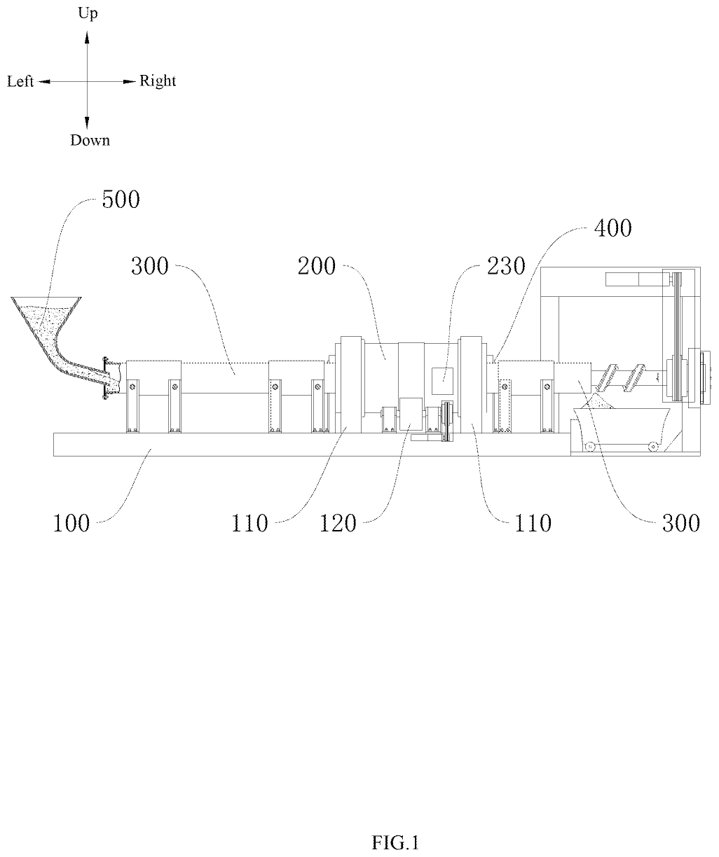

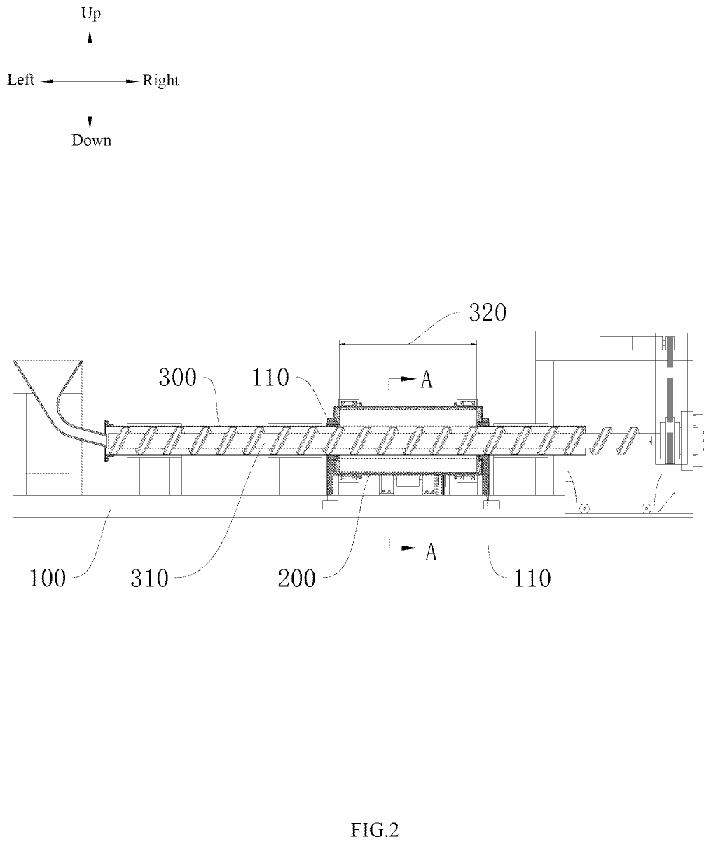

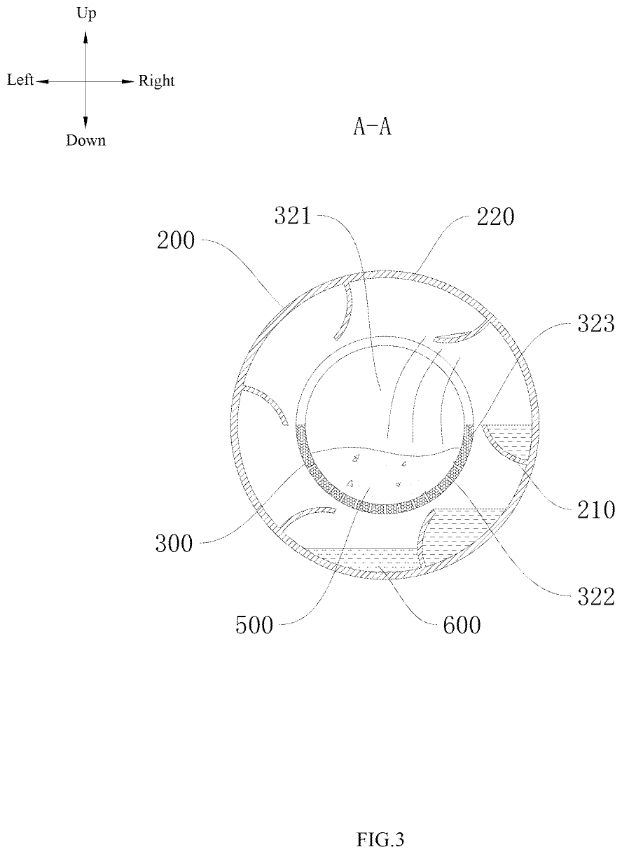

Referring to FIG. 1, according to an embodiment of the present disclosure, a hydrogen concentration-controllable safe reaction tank for leaching of waste battery powder includes a bed 100, a rotary acid pumping barrel 200 and a delivery pipe 300. Supporting frames 110 and a driver 120 are mounted on the bed 100. The rotary acid pumping barrel 200 is articulated with the supporting frames 110, and the driver 120 is configured to drive the rotary acid pumping barrel 200 to rotate. The delivery pipe 300 is mounted on the bed 100 and passes through the rotary acid pumping barrel 200, and as shown in FIG. 2, a screw 310 for pushing material is disposed in the delivery pipe 300. The delivery pipe 300 includes a pouring section 320 located in the rotary acid pumping barrel 200. As shown in FIG. 3, the pouring section 320 is provided with a pouring opening 321 at an upper portion and acid leakage holes 322 at a bottom, and at least one acid pumping plate 210 is mounted on an inner wall of the rotary acid pumping barrel 200. The driver 120 is configured to drive the rotary acid pumping barrel 200 to rotate, so that the acid pumping plate 210 can scoop up acid liquor 600 and pour the acid liquor 600 into the pouring section 320.

For example, as shown in FIG. 1, left end right ends of the delivery pipe 300 are open (the left end is a feed inlet and the right end is a discharge outlet). After a waste battery powder 500 is fed via the feed inlet 340, a motor drives the screw 310 to rotate, and the screw 310 pushes the waste battery powder 500 to move to the pouring opening 321 along the delivery pipe 300, as shown in FIG. 3. At this point, the driver 120 drives the rotary acid pumping barrel 200 to rotate, and after the acid pumping plate 210 scoops up the acid liquor 600 at the bottom of the rotary acid pumping barrel 200, the acid liquor 600 is poured into the delivery pipe 300 via the pouring opening 321 arranged in an upper portion of the delivery pipe 300. After reacting with the battery powder in the delivery pipe 300, the acid liquor 600 leaks back to the bottom of the rotary acid pumping barrel 200 via the acid leakage holes 322 arranged in the delivery pipe 300. Through repetitive scooping up by the rotary acid pumping barrel 200 and pouring, the acid liquor 600 continues to react with the waste battery powder 500. After sufficient reaction of the waste battery powder, the screw 310 continues to push the completely reacted battery powder into a cart or a receiving trough from the discharge outlet, completing the production reaction process. Specifically, as shown in FIG. 2, the rotary acid pumping barrel 200 is of a sealed circular container structure, the rotary acid pumping barrel 200 has an axis parallel to a horizontal plane, and left and right ends of the rotary acid pumping barrel 200 are provided with through holes. There are two supporting frames 110 which are separately arranged on the left and the right. The left end and right end of the rotary acid pumping barrel 200 are rotatably and sealingly connected to the supporting frames 110, respectively. The rotary acid pumping barrel 200 is divided into two layers, with an inner layer being a polyformaldehyde (POM) anti-corrosion layer and an outer layer being a stainless steel reinforcing layer. The pouring section 320 has a length less than or equal to a distance between the through holes of the left end and right end of the rotary acid pumping barrel 200, and the length of the pouring opening 321 along an axial direction of the delivery pipe 300 is less than the length of the pouring section 320. There may be multiple acid leakage holes 322, which are evenly distributed in the bottom of the pouring section 320. If there are multiple acid pumping plates 210, the multiple acid pumping plates 210 are evenly disposed along the circumference of a sidewall of the rotary acid pumping barrel 200. The length of the acid pumping plate 210 along the axial direction of the rotary acid pumping barrel 200 is less than the height of the rotary acid pumping barrel 200. Under the condition that the acid pumping plate 210 can scoop up the acid liquor 600, the cross section of the acid pumping plate 210 may be V-shaped, arc-shaped or other shapes.

According to the present disclosure, by adjusting the rotational speed of the screw 310 and the rotational speed of the rotary acid pumping barrel 200, the speed of the waste battery powder 500 moving forward in the screw propulsion barrel and the pouring speed of the acid pumping plate 210 can be controlled, so that the degree of sufficiency of the reaction of the waste battery powder 500 can be controlled. The screw 310 includes a feed section, a pouring section 320 and a discharge section. Because both the feed section and the discharge section use the screw 310 to deliver the waste battery powder 500, when enough waste battery powder 500 is fed into the feed inlet 340, the waste battery powder 500 will be piled up at the feed section and discharge section of the screw 310, the piled waste battery powder 500 can block the outside air from entering the screw propulsion barrel via the feed inlet 340 or the discharge outlet, thus preventing the change of the volume concentration of hydrogen in the screw propulsion barrel caused by the mutual communication of air and the leakage of the hydrogen, and therefore the volume concentration of the hydrogen can be conveniently controlled. For example, before production is started, high-purity hydrogen can be injected into the rotary acid pumping barrel 200, and since the hydrogen can be prevented from leaking out during operation, the volume concentration of the hydrogen in the rotary acid pumping barrel 200 is always higher than a maximum explosive limit concentration, preventing the danger of hydrogen explosion.

In some embodiments of the present disclosure, as shown in FIG. 3, taking a first cross section 220 of the rotary acid pumping barrel 200, the acid pumping plate 210 is arc-shaped in the first cross section 220, and a concave portion of the acid pumping plate 210 faces outside the rotary acid pumping barrel 200. The acid pumping plate 210 is arc-shaped to scoop up the acid liquor 600 by a maximum amount, thereby increasing the reaction rate.

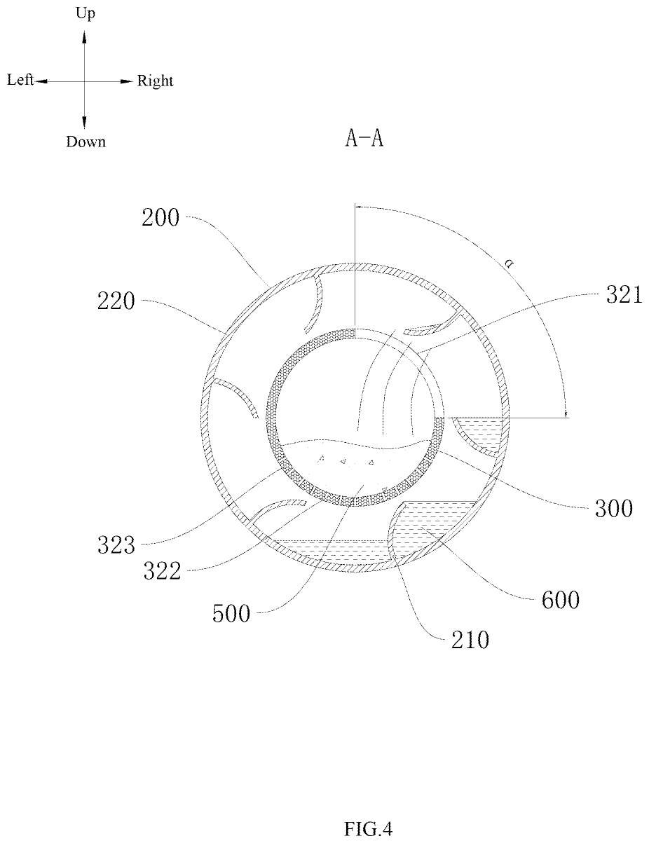

In a further embodiment of the present disclosure, as shown in FIG. 3 and FIG. 4, taking a second cross section 323 of the pouring section 320, an included angle between both ends of the pouring opening 321 is defined as α in the second cross section 323, and α<180°.

For example, the opening adopts the form of a quarter of a circular arc (i.e., α=45°) or the form of a tenth of a circular arc (i.e., α=36°), which can prevent the acid liquor 600 from easily splashing when poured and the waste battery powder from splashing out.

In some embodiments of the present disclosure, as shown in FIG. 1, the hydrogen concentration-controllable safe reaction tank for leaching of waste battery powder further includes a gas storage device 400, which includes a vacuum pump (not shown in the drawing) and a reservoir (not shown in the drawing). A gas outlet end of the vacuum pump is connected to the reservoir, and a gas suction end of the vacuum pump is communicated with the interior of the rotary acid pumping barrel 200. The gas storage device 400 is provided to prevent an overhigh gas pressure in the rotary acid pumping barrel 200, prevent the hydrogen from leaking out through the battery powder, facilitate the suction and storage of the hydrogen and ensure the fully closed design of the reaction tank to effectively guarantee the purity of the collected hydrogen.

In a further embodiment of the present disclosure, the hydrogen concentration-controllable safe reaction tank for leaching of waste battery powder further includes a controller (not shown in the drawings). A hydrogen detector (not shown in the drawings) is mounted in the rotary acid pumping barrel 200. The controller is electrically connected to the hydrogen detector, the vacuum pump and the driver 120, respectively.

For example, the hydrogen detector, which may be of an on-line type, is used for displaying a volume concentration value of hydrogen in real time. If the volume concentration of the hydrogen decreases and approaches an upper explosive limit or the concentration of the hydrogen is about 85% in the process of reaction, the hydrogen detector sends a feedback to the controller, and the controller controls the rotational speed of the rotary acid pumping barrel 200 or the hydrogen section speed of the vacuum pump, so that the reaction zone and the feeding and discharge zone are always kept outside the explosive limit of the hydrogen.

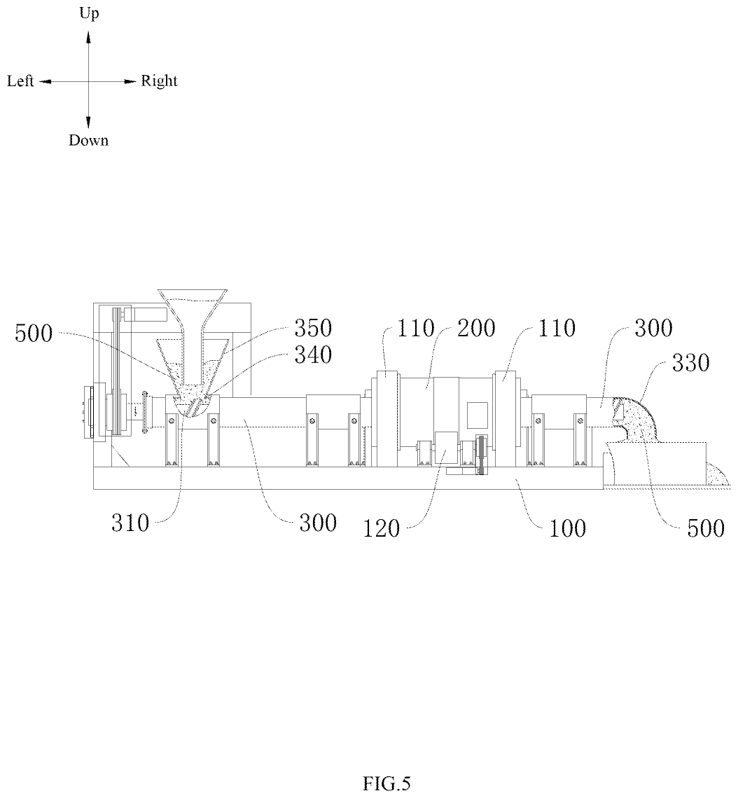

In a further embodiment of the present disclosure, as shown in FIG. 5, one end of the delivery pipe 300 is an opening, while the other end is a seal. The opening is provided with a downwardly bending elbow 330, and delivery pipe 300 is provided with a feed inlet 340 at a portion of the close to the seal. A feed hopper 350 is disposed over the feed inlet 340, with an outlet end of the feed hopper 350 being sealingly connected to the feed inlet 340. For example, the feed inlet 340 is disposed on the top of the delivery pipe 300, and the feed hopper 350 is disposed over the delivery pipe 300. The waste battery powder 500 falls into the feed inlet 340 by its own weight. Because the outlet end of the feed hopper 350 is sealingly connected to the feed inlet 340 and a lot of waste battery powder 500 is piled in the feed hopper 350, the outside air is further prevented from entering the rotary acid pumping barrel 200. Since the discharge outlet is provided with the downwardly bending elbow 330, the outside air is further prevented from entering the rotary acid pumping barrel 200 as well.

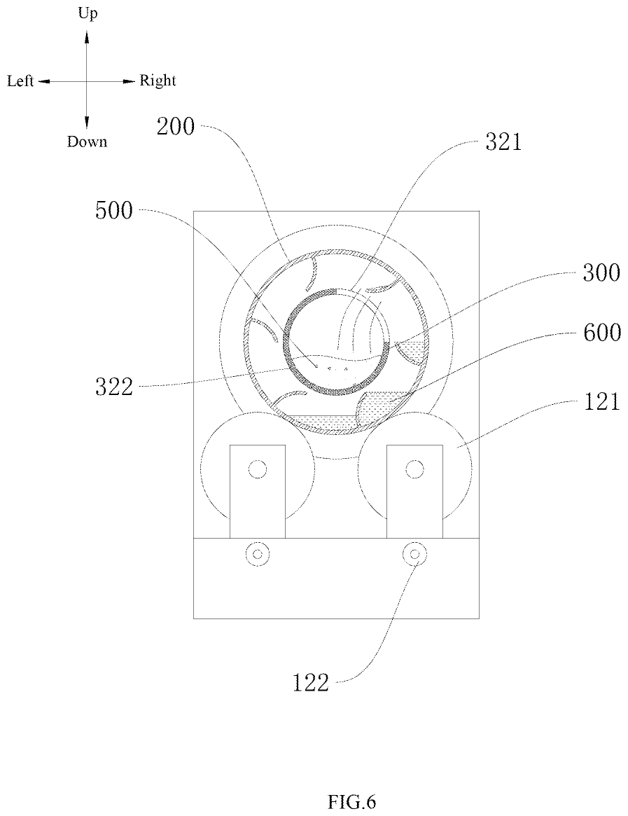

In a further embodiment of the present disclosure, as shown in FIG. 6, the supporting frames 110 support left and right ends of the rotary acid pumping barrel 200. The driver 120 includes driving wheels 121 and motors 122, and the driving wheels 121 are mounted under the rotary acid pumping barrel 200 and abut against the external surface of the rotary acid pumping barrel 200.

In a further embodiment of the present disclosure, as shown in FIG. 1, the rotary acid pumping barrel 200 is provided with a sealing door 230. The sealing door 230 can play a sealing role during production, and can be opened for cleaning of the interior of the rotary acid pumping barrel 200 during maintenance (cleaning off the battery powder remaining in the rotary acid pumping barrel 200).

In a further embodiment of the present disclosure, the surface of the driving wheel 121 is provided with a rubber layer. The rubber layer plays the role of increasing friction, and besides, the surface of the rubber layer can also have the effect of elastic buffering for shock absorption, preventing the rotary acid pumping barrel 200 and the screw 310 from being deformed and damaged due to mutual violent shock.

In a further embodiment of the present disclosure, the screw 310 and an inner wall of the delivery pipe 300 are coated with plastic layers. The plastic layers are made of polyformaldehyde (abbreviated as POM) to prevent the screw 310 and the inner wall of the delivery pipe 300 from being corroded, so that the service life of the reaction tank can be prolonged.

In the description of the present specification, the description of reference terms, such as “some embodiments” or “It is conceivable that”, means that the specific features, structures, materials or characteristics described in reference to the embodiment or example are included in at least one embodiment or example of the present disclosure. In the present specification, the schematic description of the aforementioned terms does not necessarily refer to the same embodiment or example. Moreover, the specific features, structures, materials or characteristics described may be combined in any one or more embodiments or examples in an appropriate manner.

Although the embodiments of the present disclosure have been illustrated and described, it can be understood by those of ordinary skill in the art that various changes, modifications, replacements and variations can be made to these embodiments without departing from the principle and purpose of the present disclosure, and the scope of the present disclosure is defined by the claims and equivalents therefore.

1. A hydrogen concentration-controllable safe reaction tank for leaching of waste battery powder, comprising:
a bed provided with supporting frames and a driver;
a rotary acid pumping barrel articulated with the supporting frames, wherein the rotary acid pumping barrel is of a sealed circular container structure, the supporting frames comprise two supporting frames which are separately arranged on the left and the right, the left end and right end of the rotary acid pumping barrel are rotatably and sealingly connected to the two supporting frames, respectively, and the driver is configured to drive the rotary acid pumping barrel to rotate;
a delivery pipe mounted on the bed and passing through the rotary acid pumping barrel, wherein a screw for pushing material is disposed in the delivery pipe; the delivery pipe comprises a pouring section, a feed section, and a discharge section located in the rotary acid pumping barrel, the pouring section is provided with a pouring opening at an upper portion and acid leakage holes at a bottom; at least one acid pumping plate is mounted on an inner wall of the rotary acid pumping barrel, and the driver is configured to drive the rotary acid pumping barrel to rotate, so that the acid pumping plate can scoop up an acid liquor and pour the acid liquor into the pouring section;
a gas storage device, comprising a vacuum pump and a reservoir, wherein a gas outlet end of the vacuum pump is connected to the reservoir, and a gas suction end of the vacuum pump is communicated with the interior of the rotary acid pumping barrel; and
a controller, wherein a hydrogen detector is mounted in the rotary acid pumping barrel, and the controller is electrically connected to the hydrogen detector, the vacuum pump and the driver, respectively.

2. The hydrogen concentration-controllable safe reaction tank for leaching of waste battery powder of claim 1, wherein taking a first cross section of the rotary acid pumping barrel, the acid pumping plate is arc-shaped in the first cross section, and a concave portion of the acid pumping plate faces outside the rotary acid pumping barrel.

3. The hydrogen concentration-controllable safe reaction tank for leaching of waste battery powder of claim 1, wherein taking a second cross section of the pouring section, an included angle between both ends of the pouring opening is defined as α in the second cross section, and α<180°.

4. (canceled)

5. (canceled)

6. The hydrogen concentration-controllable safe reaction tank for leaching of waste battery powder of claim 1, wherein one end of the delivery pipe is an opening, while the other end is a seal; the opening is provided with a downwardly bending elbow, and the delivery pipe is provided with a feed inlet at a portion close to the seal; and a feed hopper is disposed over the feed inlet, with an outlet end of the feed hopper being sealingly connected to the feed inlet.

7. The hydrogen concentration-controllable safe reaction tank for leaching of waste battery powder of claim 1, wherein the supporting frames support left and right ends of the rotary acid pumping barrel, the driver comprises driving wheels and motors, and the driving wheels are mounted under the rotary acid pumping barrel and abut against the external surface of the rotary acid pumping barrel.

8. The hydrogen concentration-controllable safe reaction tank for leaching of waste battery powder of claim 1, wherein the rotary acid pumping barrel is provided with a sealing door.

9. The hydrogen concentration-controllable safe reaction tank for leaching of waste battery powder of claim 7, wherein the surface of the driving wheel is provided with a rubber layer.

10. The hydrogen concentration-controllable safe reaction tank for leaching of waste battery powder of claim 1, wherein the screw and an inner wall of the delivery pipe are coated with plastic layers.

11. The hydrogen concentration-controllable safe reaction tank for leaching of waste battery powder of claim 2, wherein taking a second cross section of the pouring section, an included angle between both ends of the pouring opening is defined as α in the second cross section, and α<180°.

12. The hydrogen concentration-controllable safe reaction tank for leaching of waste battery powder of claim 2, wherein one end of the delivery pipe is an opening, while the other end is a seal; the opening is provided with a downwardly bending elbow, and the delivery pipe is provided with a feed inlet at a portion close to the seal; and a feed hopper is disposed over the feed inlet, with an outlet end of the feed hopper being sealingly connected to the feed inlet.

13. The hydrogen concentration-controllable safe reaction tank for leaching of waste battery powder of claim 2, wherein the supporting frames support left and right ends of the rotary acid pumping barrel, the driver comprises driving wheels and motors, and the driving wheels are mounted under the rotary acid pumping barrel and abut against the external surface of the rotary acid pumping barrel.

14. The hydrogen concentration-controllable safe reaction tank for leaching of waste battery powder of claim 2, wherein the rotary acid pumping barrel is provided with a sealing door.

15. The hydrogen concentration-controllable safe reaction tank for leaching of waste battery powder of claim 2, wherein the screw and an inner wall of the delivery pipe are coated with plastic layers.

16. The hydrogen concentration-controllable safe reaction tank for leaching of waste battery powder of claim 13, wherein the surface of the driving wheel is provided with a rubber layer.
